(19) United States
(12) Patent Application Publication
(10) Pub. No.: US 2012/0291261 A1
(43) Pub. Date: Nov. 22, 2012

(54) HANGING STORAGE C-CHANNEL SPLICE SYSTEM

(76) Inventor: Matthew Davis, Rancho Santa Margarita, CA (US)

(21) Appl. No.: 13/357,512

(22) Filed: Jan. 24, 2012

Related U.S. Application Data
(60) Provisional application No. 61/487,704, filed on May 18, 2011.

(51) Int. Cl. F16B 5/00; B23P 11/00

(52) U.S. Cl. 29/525.01; 403/292

(57) ABSTRACT

A hanging storage system is presented with an improved support beam splicing method that allows the use of short metal beams to carry the load of a long beam. The support beams are three-sided angle iron product with a C-shaped cross section designed to permit a system assembled from such products to carry increased weight of stored items.

### RELATED APPLICATIONS

This application claims the benefit of U.S. Provisional Patent Application 61/487,704, filed May 18, 2011.

### FIELD OF THE INVENTION

This invention relates to the area of storage systems for home and industrial use, specifically those designed to be retrofitted to existing structures, such as garages or storage units.

### BACKGROUND OF THE INVENTION

The typical storage scenario involves identifying square footage of a building to be set aside for storage, where items will be stacked on the floor. A storage structure supported from the ceiling of a building increases the capacity of storage space by permitting items to be placed well above the floor, for example in the ceiling area of a garage.

There is a long history of such storage structures in the art, including U.S. Pat. Nos. 6,715,427 and 6,435,105 to Mikich, et al., 6,725,608 to Kraus, 7,357,262 to Fratilla, 7,543,538 and 7,421,957 to Baez, and. These are the most recent inventions, and they primarily address the garage ceiling storage problem. Each has their own mechanism for attachment to the ceiling rafters, and unique rack designs. The Baez patents also show a splicing technique for beams.

The present invention adapts the state of the art and moves it forward by supplying a simplified splicing system to allow easy connection of improved angle iron connectors and C-shaped three-sided horizontal beam supports without weakening the strength of the hanging support system.

The ability to splice two or more shorter support beams into one long beam improves the storability and transportability of the entire hanging support system, permitting boxes of components to be moved and installed more easily.

### SUMMARY OF THE INVENTION

Current models of ceiling storage racks for garages share some general design characteristics: they fasten to garage ceilings at 4 or 6 points with vertical risers descending to connect with four horizontal members that form a rectangular frame. The risers can be adjusted for length to match slanted rafter beams and the like.

A metal screen or wire mesh is placed over the frame to serve as the floor of the storage space. The screen is designed to support loads of a stated weight.

Fratilla teaches a ceiling attachment bracket capable of spanning standard ceiling truss separations, usually 16″ to 24″. This is done with a special angle iron fitted with two connection points. The installation process is made easier and a stronger, and a two-connection-point attachment is made with the truss. This attachment strategy increases the load capacity of the present invention over earlier designs.

Note that in the Mikich patents, the “adapters” provided are very short, and will not account for multiple-beam connection with beams that are a nonstandard distance apart. Fratilla provides significantly wider attachment brackets instead of adapters, permitting the installer to find a much more convenient attachment point for placing bolt holes closer to the center of the ceiling truss.

Fratilla also teaches a three-sided, C-shaped longitudinal beam for the support rack frame, providing substantial strength improvements over the standard two-sided angle iron

### BRIEF DESCRIPTION OF THE DRAWINGS

The features of this invention will be best understood from the accompanying drawings, taken in conjunction with the accompanying description.

FIG. 1 is a perspective view of the splice panel

FIG. 2 is a perspective view of a support truss

FIG. 3 is an exploded view of the assembly of the invention

### DESCRIPTION OF THE PREFERRED EMBODIMENT

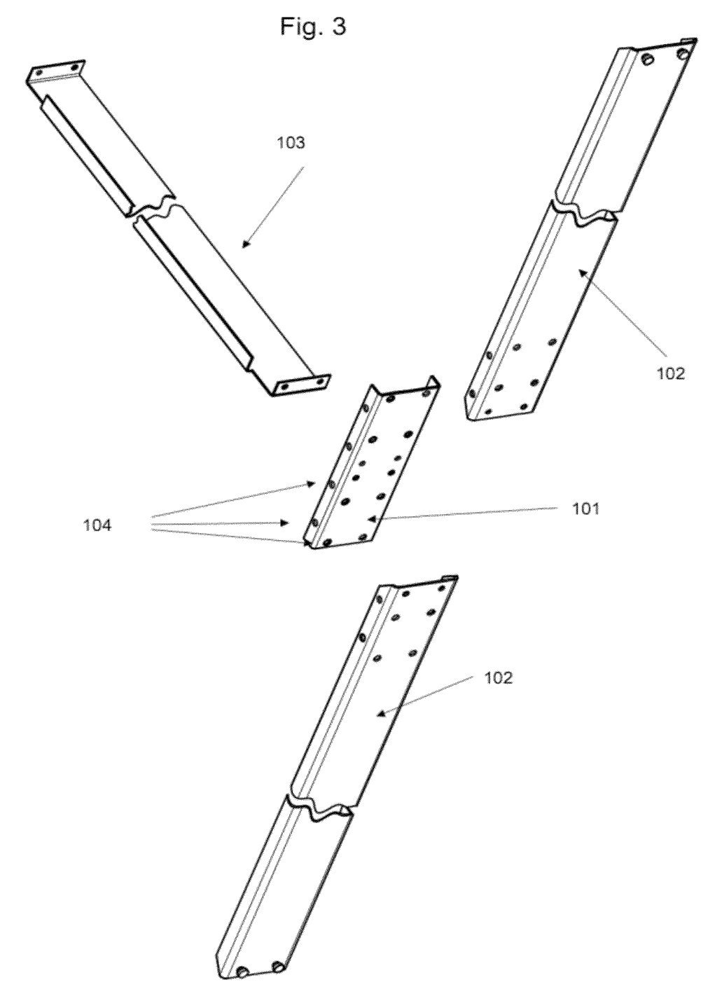

The present invention is shown in a perspective overview in FIG. 3. The invention is shown as a typical splice operation, connecting two truss members 102 and a cross beam 103 using the splice panel 101.

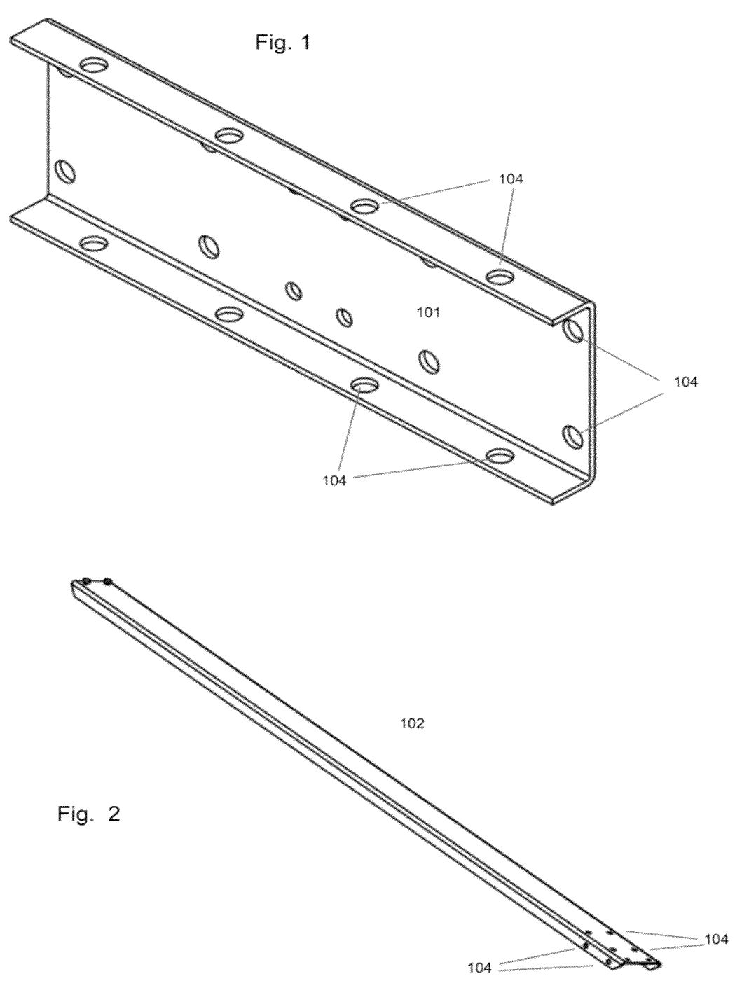

FIG. 1 shows the splice panel 101 in close-up, with the drilled connector holes 104 used to connect each of the truss members and the cross beam 103. In the preferred embodiment, the truss members 102 are made from C-shaped-cross-section, three-sided angle iron product to provide greater strength and stiffness to the frame. The C-shaped cross-section beam reduces the need for an intermediate riser, where that would be desirable, allowing for the storage of bulkier items.

Assembly of the invention would consist of selecting the ceiling airspace to be occupied by the storage area and assembling the necessary length of support truss from the truss members 102, using a plurality of splice panels 101 to connect a plurality of said truss members 102 in sequence. The splice panels 101 would provide attachment points for the cross beams 103, and a rectangular framework would thereby be assembled. After the framework is assembled, a metal mesh floor can be laid over the frame.

While the foregoing describes a preferred embodiment, variation on this design and equivalent designs may be resorted to in the scope and spirit of the claimed invention.

What is claimed is

1. a spliced support member, comprised of a plurality of truss members, cross beams, and splice panels,
each splice panel a flat piece of rigid material, the splice panel penetrated with a plurality of connector holes,
each truss member made from elongated, three-sided, angled, rigid material, the truss members possessing connector holes at each end,
each cross beam made from three-sided, angled, rigid material, the cross beams possessing connector holes at each end:

2. The spliced support member of claim 1 where the three-sided, angled, rigid material possesses a C-shaped cross-section and the rigid material is iron or steel.

3. A method of assembly of a spliced support member as in claim 2 comprised of the steps of
selecting the airspace to be occupied by a vertical storage area,
using a plurality of splice panels to connect a plurality of truss members in sequence by means of removable connectors passed through the connector holes of the splice panels,
using the splice panels' connector holes as attachment points for a plurality of cross beams producing a rectangular framework,
after the rectangular framework is assembled, laying a metal mesh floor over the framework such that the rectangular framework supports the mesh floor.
